(19) United States
(12) Patent Application Publication
(10) Pub. No.: US 2008/0174942 A1
(43) Pub. Date: Jul. 24, 2008

(54) Handheld Electronic Device

(75) Inventors: Sheng-Yu Yang, Taipei (TW); Yen-Chih Lin, Taipei (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: ASUSTEK COMPUTER INC., Taipei (TW)

(21) Appl. No.: 11/778,208

(22) Filed: Jul. 16, 2007

(30) Foreign Application Priority Data
Jan. 19, 2007 (TW) 96102224

(51) Int. Cl. G06F 1/16; E05D 11/00; H01R 3/00

(52) U.S. Cl. 361/680; 16/223; 361/681; 439/165

(57) ABSTRACT

A handheld electronic device of the present invention including a body, a display portion, and a connection portion. The connection portion connects the body and the display portion such that the display portion can slide on the body and pivot relative to the body. The connection portion includes a hinge and two plates. The hinge is disposed in a recess on the body. The first plate is connected with the display portion. The second plate is connected with the first plate in a sliding method. One edge of the second plate is fixed on the hinge. When the display portion exposes the hinge, the display portion is able to pivot relative to the body.

### RELATED APPLICATIONS

This application claims priority to Taiwan Application Serial Number 96102224, filed Jan. 19, 2007, which is herein incorporated by reference.

### BACKGROUND OF THE INVENTION

1. Field of the Invention

The invention relates to a handheld electronic device and, more particularly, to a handheld electronic device with both a sliding mechanism and a pivoting mechanism.

2. Description of the Related Art

FIG. 1 it is a diagram showing a conventional handheld electronic device. A handheld electronic device 100 includes a body 104 and a display portion 102. The display portion 102 can manually or semi-automatically slide on the body 104 to cover or expose a keypad 104a on the body 104. When a user wants to use the keypad to input information, he can slide the display portion 102 to expose the keypad 104a on the body 104. When the user need not use the keypad to input information, he can slide the display portion 102 to cover the keypad 104a on the body 104. An electronic device with sliding cover design has become one of the most popular electronic devices not only for esthetics reasons but also for the lower miss-input rate since the input element (the keypad) is protected by the sliding cover.

However, the above design only makes the display portion 102 slide in a direction parallel to the body 104 and fails to make a screen 102a on the display portion 102 tilt upwardly to a better viewing angle, and therefore the application of this design is limited. For example, when the user places the body 104 on the table and uses the keypad 104a to input information, the display portion 102 incapable of tilting upwardly in the conventional electronic device may be inconvenient for the user to watch the screen 102a. Furthermore, if the user wants to view image files stored in such the electronic device that its display portion fails to pivot freely, the user has to adjust the best viewing angle by other ways, and therefore it is inconvenient for the user.

Since software functions of the handheld electronic device increase day by day, diversified designs in hardware are needed to meet more and more diversified needs, and therefore it is necessary to develop an electronic device with both the functions of sliding and pivoting the display.

### BRIEF SUMMARY OF THE INVENTION

An objective of the invention is to provide a handheld electronic device with both a sliding mechanism and a pivoting mechanism, so that a display portion can slide parallelly and pivot relative to a body to adjust the display portion to a better viewing angle.

According to the above objective, the invention provides a handheld electronic device including a body, a display portion, and a connection portion. The body has an input unit for a user to input information. The display portion has a display unit for the user to view images. The connection portion connects the body and the display portion, so that the display portion can slide on the body and pivot relative to the body.

The connection portion includes at least a hinge and two plates, wherein the hinge is fixed in the body, the first plate is connected with the display portion, the second plate is connected with the first plate in a way of sliding, and at least one edge of the second plate is fixed on the hinge.

When the display portion on the first plate slides to expose the hinge, the display portion can pivot relative to the body, so that it is convenient for the user to watch.

In a preferred embodiment, a form of the input unit on the body of the handheld electronic device may not be limited and preferably may be a keypad, and the display unit preferably may be a screen.

In a preferred embodiment, the handheld electronic device of the present invention may further include a positioning mechanism connected with the first plate and the display portion. With the positioning mechanism, the display portion can be pivoted to meet the user's requirements when the display portion slides to the position to expose the hinge on the body. Furthermore, the second plate may further include several salient points for interfering with the positioning mechanism further to determine positions where the display portion can pivot relative to the body.

In a preferred embodiment, the handheld electronic device may further include a push unit between the first plate and the second plate for connecting the two plates and providing thrust to produce a semi-automatic sliding when the first plate slides relative to the second plate. Structure of the push unit may not be limited and preferably may be a spring or a magnetic element.

In a preferred embodiment, the body may include a recess for containing the hinge. The hinge may include a shaft fixed in the recess and a sleeve fixed on one side edge of the second plate to connect the shaft and the second plate and to make the display portion pivot relative to the body.

Further, in a preferred embodiment, the handheld electronic device may further include a connecting wire for electrically connecting the display portion and the body, wherein the connecting wire preferably may be a flexible flat cable or a flexible circuit board.

The handheld electronic device of the invention can make the display portion slide on the body and pivot relative to the body via the connection portion, so that the user can flexibly adjust positions of the display portion.

These and other features, aspects, and advantages of the present invention will become better understood with regard to the following description, appended claims, and accompanying drawings.

### BRIEF DESCRIPTION OF THE SEVERAL VIEWS OF THE DRAWINGS

FIG. 1 is a diagram showing a conventional handheld electronic device.

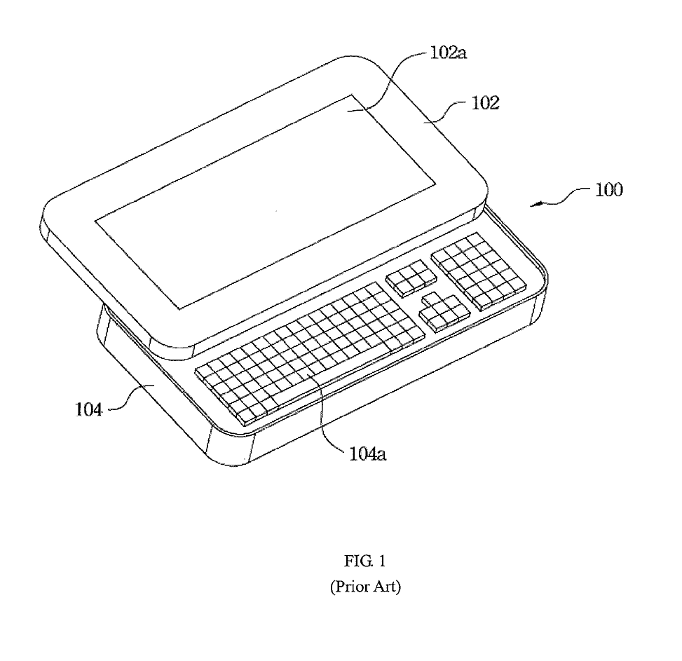

FIG. 2 is a diagram showing a handheld electronic device according to a preferred embodiment of the invention.

FIG. 3 is a diagram showing a connection portion between a body and a display portion of a handheld electronic device according to a preferred embodiment of the invention.

FIG. 4 is a cross-sectional view of a handheld electronic device after a display portion slides parallel to a body to a first salient point in a preferred embodiment of the invention.

FIG. 5 is a cross-sectional view of a handheld electronic device after a display portion slides parallel to a body to a second salient point in a preferred embodiment of the invention.

FIG. 6 is a diagram showing a connection portion between a body and a display portion of a handheld electronic device according to another preferred embodiment of the invention.

FIG. 7 is cross-sectional view of a handheld electronic device according to another preferred embodiment of the invention.

### DETAILED DESCRIPTION OF THE EMBODIMENTS

As described above, the invention provides a handheld electronic device. The handheld electronic device includes a connection portion for connecting a body and a display portion thereof, so that the display portion can slide on the body and pivot relative to the body to make a user flexibly adjust positions of the display portion. The following embodiments show details of the invention.

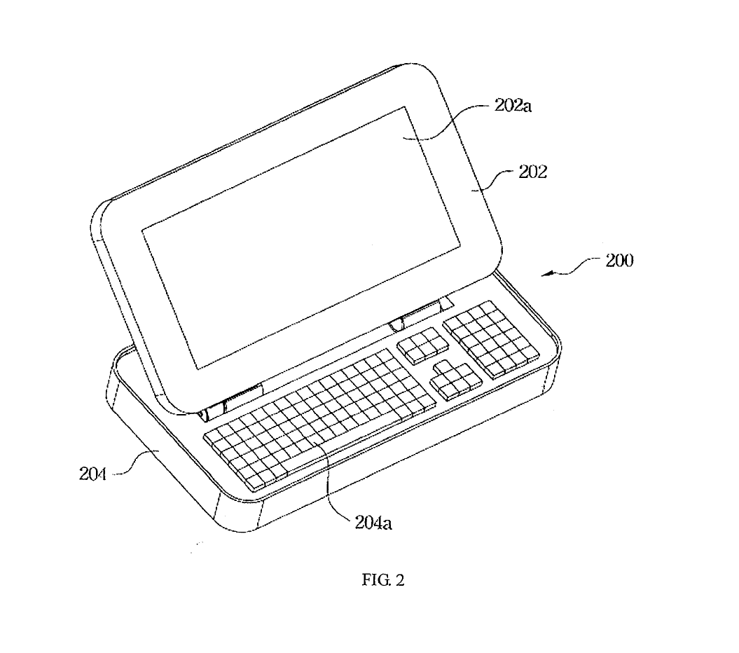

FIG. 2 is a diagram showing a handheld electronic device according to a preferred embodiment of the invention. The handheld electronic device 200 can be a cell phone, a personal digital assistant (PDA), a handheld computer, or an intelligent mobile phone.

In this embodiment, the handheld electronic device 200 mainly includes a body 204 and a display portion 202. The body 204 has an input unit, which is a keypad 204a in this embodiment, for the user to input information. Furthermore, the display portion 202 has a display unit, which is a screen 202a in this embodiment, for outputting images or other information for the user to view. The display portion 202 not only can slide on the body 204 (when the display portion 202 and the body 204 are parallel) but also can pivot relative to the body 204 (as shown in FIG. 2), so that the use can flexibly adjust positions of the display portion 202.

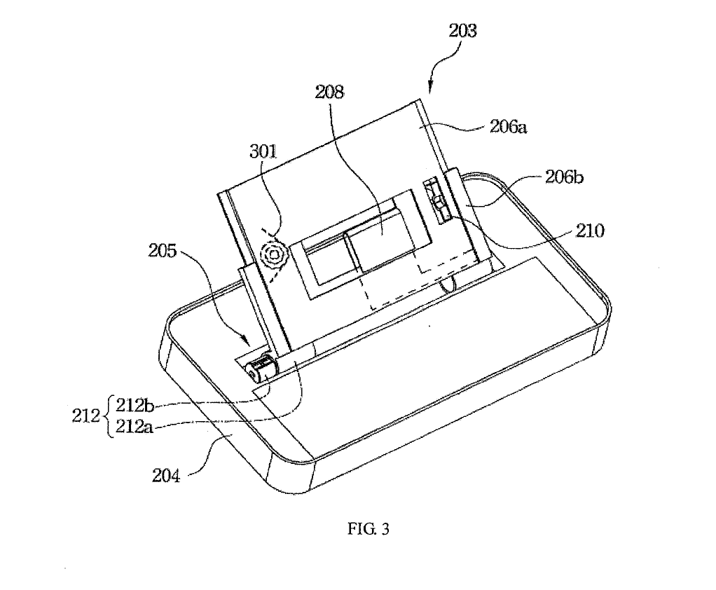

FIG. 3 is a diagram showing a connection portion between a body and a display portion of a handheld electronic device according to a preferred embodiment of the invention. This figure shows the handheld electronic device of which the display portion 202 is removed in FIG. 2. The connection portion includes a first plate 206a, a second plate 206b, and a hinge 212. The first plate 206a is connected with the back of the display portion 202 (the face without the screen 202a and not shown in the figure). The second plate 206b is connected to part side edges of two sides of the first plate 206a to form a sliding connection, so that the first plate 206a can slide relative to the second plate 206b further to make the display portion 202 connected with the first plate 206a slide on the body 204.

In this embodiment, when the first plate 206a slides relative to the second plate 206b, a spring 301 provides a force, and after the first plate 206a is pushed upwardly to a distance (passing the inflection point of the spring), a semi-automatic sliding is produced via the thrust of the spring 301 so that the screen can get thrust in the onward movement. The spring 301 can be disposed on the first plate 206a or the second plate 206b. Besides the spring, other known elements which can provide a semi-automatic sliding such as a magnetic element can also be used.

The hinge 212 includes a sleeve 212a and a shaft 212b. The sleeve 212a is fixed on one side edge of the second plate 206b. The shaft 212b is fixed in a recess 205 of the body 204. The sleeve 212a is sleeved onto the shaft 212b, so that the first plate 206a and the second plate 206b can pivot relative to the body 204 further to make the display portion 202 pivot relative to the body 204.

In this embodiment, the connection portion needs a connecting wire 208 to be a medium for electrical connection between the display portion 202 and the body 204. The connecting wire 208 is hidden behind the second plate 206 and connects the display portion 202 and the body 204 through openings in the first plate 206a and the second plate 206b. The connecting wire 208 can be a flexible flat cable or a flexible circuit board to bend according to the sliding of the first plate 206a relative to the second plate 206b.

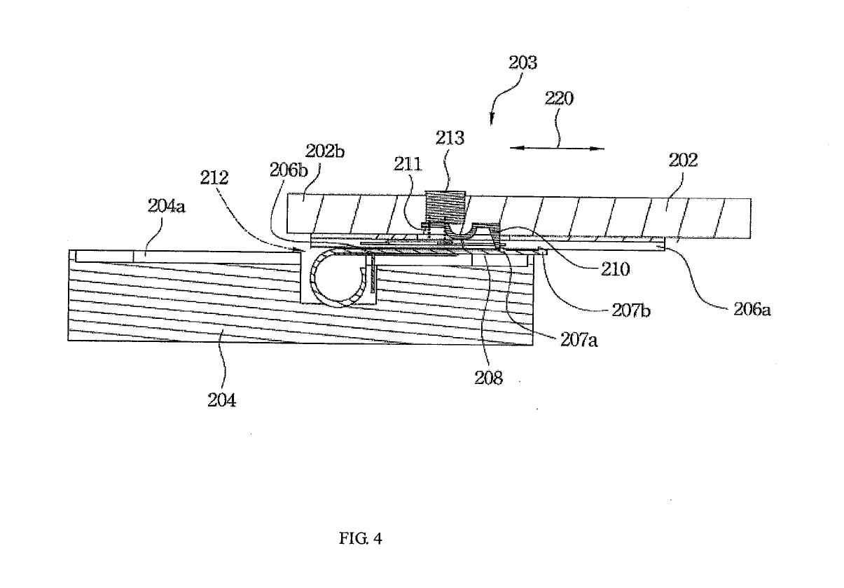

FIG. 4 is a cross-sectional view of a handheld electronic device according to a preferred embodiment of the invention. In FIG. 4, the second plate 206b has a first salient point 207a and a second salient point 207b, and a positioning mechanism 210 is disposed inside the first plate 206a and the display portion 202. After the display portion 202 slides along a direction 220 to a predetermined position on the body 204, the positioning mechanism 210 inside the display portion 202 may first touch the first salient point 207a on the second plate 206b and then may be interfered with. At this moment, the display portion 202 is positioned where a portion of the body 204a is completely exposed, and therefore in this embodiment the input unit 204a on the body 204 can be exposed for the user to input information.

When the positioning mechanism 210 touches the first salient point 207a then to be positioned, the bottom edge 202b of the display portion 202 may be blocked by the body 204 because there is no containing space such as grooves on the body 204, so that the display portion 202 may fail to pivot freely. Therefore, before the positioning mechanism 210 inside the display portion 202 touches the first salient point 207a on the second plate 206b, the display portion 202 can slide only along the direction 220 parallel to the body 204.

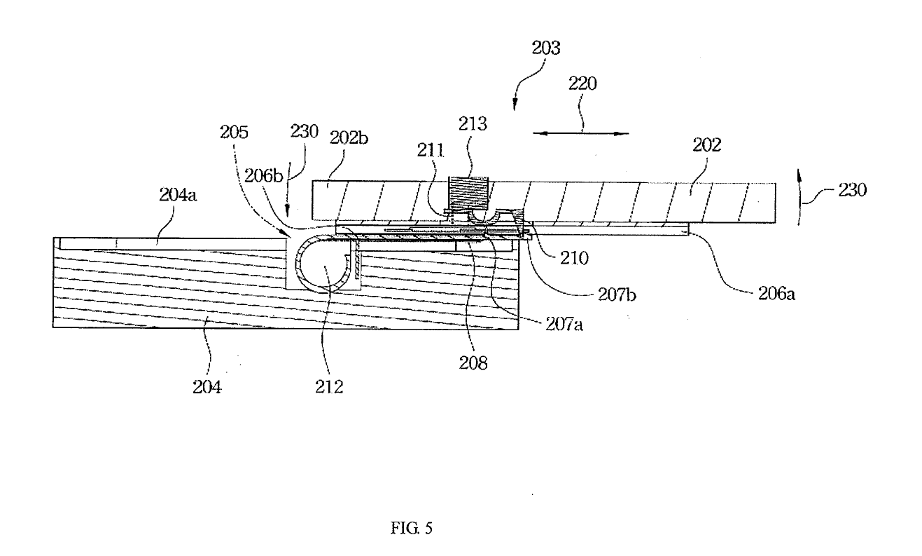

To make the user know when the display portion 202 can pivot, related pivoting elements are described as follows. In FIG. 5, the positioning mechanism 210 of the first plate 206a and the display portion 202 is further connected with a button 213 exposed out of the top surface of the display portion 202. When the button 213 is pressed, the positioning mechanism 210 may move upwardly to be free from the interference of the first salient point 207a on the second plate 206b. Then when the button 213 is released, that is, when the pressing force disappears, elasticity of a spring 211 may make the positioning mechanism 210 return to the original state to touch the second plate 206b once again. At this moment, the positioning mechanism 210 may be interfered with by the second salient point 207b on the second plate 206b, so that the hinge 212 can be completely exposed.

Since the hinge 212 is contained in the recess 205 in this embodiment and at least about one half hinge 212 is exposed when the hinge 212 parallelly moves following the display portion 202 to be interfered with by the second salient point 207b, the edge of the bottom edge 202b of the display portion 202 can be contained in the recess 205 following the pivoting of the hinge 212 to make the bottom edge 202b lower than the surface of the body 204. At this moment, as shown in FIG. 5, the display portion 202 may pivot along a direction 230 to adjust pivoting angles of the display portion 202. However, if the whole length of the display portion 202 is short, the bottom edge 202b can pivot freely free from the blocking of the body 204, and therefore when the display portion 202 pivots, the bottom edge 202b can also parallelly contact with the surface of the body 204 and even can make non-contact (that is, the bottom edge 202b of the display portion 202 need not be contained in the recess 205).

When the electronic device is used, the positioning mechanism 210 inside the display portion 202 may stop sliding because of the interference of the first salient point 207a on the second plate 206b after the display portion 202 slides along the direction 220 to a predetermined position on the body 204. At this moment, the display portion 202 can be positioned where the input unit is completely exposed while the hinge is not exposed (as shown in FIG. 4).

When the user wants to pivot the display portion 202, he can press the button 213 to drive the positioning mechanism 210 to cross over the first salient point 207a then to continue sliding. Later the positioning mechanism 210 may stop sliding once again because of the interference of the second salient point 207b on the second plate 206b (another interference). At this moment, the display portion 202 can pivot along the direction 230 relative to the body 204 (as shown in FIG. 3 and FIG. 5).

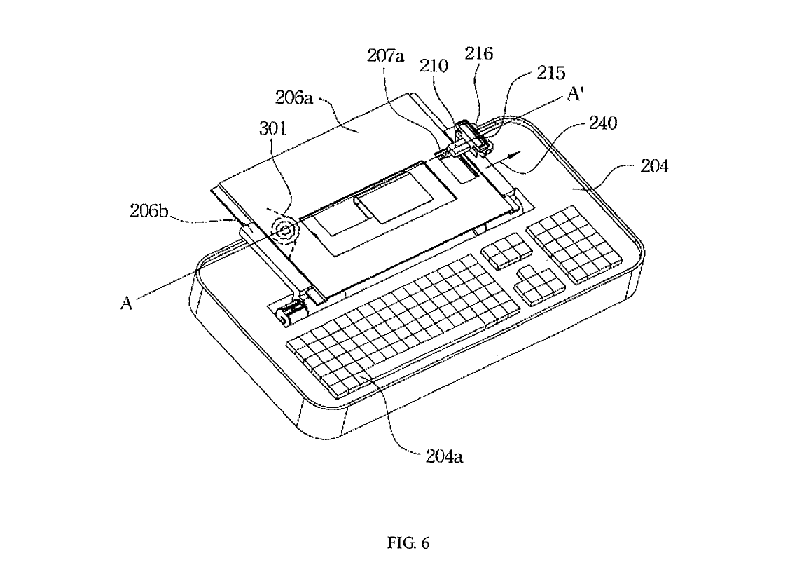

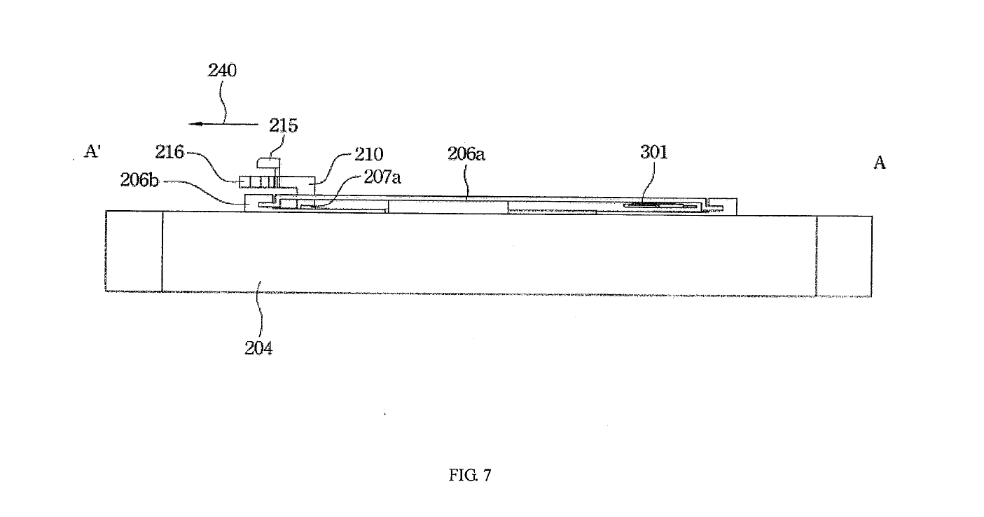

Below another executing method of the positioning mechanism may be described. Please refer to FIG. 6 and FIG. 7 together. FIG. 7 is a cross-sectional view taken along the line A-A′ in FIG. 6. The positioning mechanism 210 can be free from the interference of the first salient point 207a on the second plate in a side moving method (such as along a direction 240) besides the method of crossing over the first salient point 207a. The positioning mechanism 210 is connected with a button 215 exposed out of the display portion 202. When the button 215 is pushed sideward (along the direction 240), the positioning mechanism 210 is free from the interference of the first salient point 207a then to continue sliding. One end of an elastic sheet 216 is connected with the button 215, and the other end is fixed in the display portion (not shown in the figures). When the button 215 is not pushed sideward, elasticity of the elastic sheet 216 makes the positioning mechanism 210 move back to the position where the first salient point 207a can interfere (the state as shown in FIG. 6).

From the above preferred embodiments of the invention, it is known that the handheld electronic device according to the invention makes the display portion not only slide on the body but also pivot relative to the body via the connection portion, so that the user can flexibly adjust the positions of the display portion.

Although the present invention has been described in considerable detail with reference to certain preferred embodiments thereof, the disclosure is not for limiting the scope of the invention. Persons having ordinary skill in the art may make various modifications and changes without departing from the scope and spirit of the invention. Therefore, the scope of the appended claims should not be limited to the description of the preferred embodiments described above.

What is claimed is:

1. A handheld electronic device, comprising:
a body having at least an input unit;
a display portion having at least a display unit; and
a connection portion connecting the body and the display portion, wherein the connection portion at least comprises:
at least a hinge fixed in the body;
a first plate connected with the display portion; and
a second plate connected with the first plate in a sliding method, wherein at least one edge of the second plate is fixed on the hinge;
wherein when the display portion on the first plate slides to expose the hinge, the display portion pivots relative to the body.

2. The handheld electronic device according to claim 1, wherein the input unit is a keypad and the display unit is a screen.

3. The handheld electronic device according to claim 1, further comprising a positioning mechanism connected with the first plate and the display portion.

4. The handheld electronic device according to claim 3, wherein the second plate further comprises several salient points for interfering with the positioning mechanism.

5. The handheld electronic device according to claim 1, further comprising a push unit connecting the first plate and the second plate.

6. The handheld electronic device according to claim 5, wherein the push unit is a spring or a magnetic element.

7. The handheld electronic device according to claim 1, wherein the body comprises a recess for containing the hinge.

8. The handheld electronic device according to claim 7, wherein the hinge comprises a shaft fixed in the recess and a sleeve fixed on one side edge of the second plate to connect the shaft and the second plate.

9. The handheld electronic device according to claim 1, farther comprising a connecting wire for electrically connecting the display portion and the body.

10. The handheld electronic device according to claim 9, wherein the connecting wire is a flexible flat cable.

11. The handheld electronic device according to claim 9, wherein the connecting wire is a flexible circuit board.
